(19) United States
(12) Patent Application Publication
(10) Pub. No.: US 2012/0014412 A1
(43) Pub. Date: Jan. 19, 2012

(54) POSITIONING SYSTEM AND POSITIONING METHOD

(75) Inventors: Yoichi Nakagawa, Tokyo (JP); Takashi Fukagawa, Kanagawa (JP); Hirohito Mukai, Tokyo (JP)

(73) Assignee: PANASONIC CORPORATION, Osaka (JP)

(21) Appl. No.: 13/256,878

(22) PCT Filed: Mar. 3, 2010
(86) PCT No.: PCT/JP2010/001470

§ 371 Date: Sep. 15, 2011

(30) Foreign Application Priority Data
Mar. 17, 2009 (JP) 2009-064157

(51) Int. Cl. H04B 1/69

(52) U.S. Cl. 375/130; 375/E01.001

(57) ABSTRACT

A positioning system and a positioning method which suppress the occurrence of jitter to improve positioning accuracy. A base station (100) of a positioning system (10) which comprises the base station (100) and a radio terminal (200), and measures the position of the radio terminal (200) to be positioned using a pulse signal, wherein a pulse generating block (103) transmits a pulse signal sequence, and an ID positioning block (110) calculates the time required for reciprocation between the transmission timing of the pulse signal sequence and the reception timing of a response pulse signal sequence transmitted from the radio terminal (200) which has received the pulse signal sequence, and calculates the position of the radio terminal (200) on the basis of the time required for reciprocation. Then, in the radio terminal (200) an LNA (203) amplifies the received pulse signal sequence and transmits the amplified pulse signal sequence to the base station (100) as a response pulse signal.

### TECHNICAL FIELD

The present invention relates to a positioning system and a positioning method capable of calculating the position of an apparatus that is subject to positioning using a pulse signal.

### BACKGROUND ART

In general, a positioning system using a radio ultra-wideband (UWB) utilizes an asynchronous method in which a plurality of base stations are required. According to the asynchronous method, a reference clock of a base station is not synchronized with a reference clock of a radio terminal. The radio terminal is activated at any time and transmits, as a UWB radio signal, a pulse sequence including the ID information of this radio terminal. Here, the UWB radio signal refers to a radio signal with a bandwidth of 500 MHz or more or a bandwidth of 20% or more with respect to a central frequency.

A radio positioning system utilizing the asynchronous method is disclosed in, for example, Patent Literatures 1 and 2. The radio positioning system includes a plurality of base stations and a radio terminal. Each base station calculates the coordinates of each radio terminal by transmitting a positioning signal and measuring a time-of-arrival (TOA) necessary to receive a pulse transmitted from the radio terminal.

Unlike the asynchronous method, there is known a synchronous method of measuring the TOA by synchronizing the reference clock of a base station with the reference clock of a radio terminal. For example, Patent Literature 3 discloses a radio positioning system utilizing the synchronous method. In this radio positioning system, the radio terminal receives a pulse sequence transmitted from a base station, generates a reference clock, synchronizes this reference clock with the reference clock of the base station, and then replies the pulse sequence. Then, the base station receives the pulse sequence replied from the radio terminal and measures the TOA.

The synchronous method has an advantage that a single base station is capable of measuring the distance between the base station and a radio terminal. That is, the plurality of base stations need to be disposed around a positioning area in accordance with the asynchronous method, whereas only a single base station is setup at the center of the positioning area in accordance with the synchronous method. Accordingly, the synchronous method has an advantage that a system configuration is simpler compared to the asynchronous method.

### CITATION LIST

### Patent Literature

PTL 1
Japanese Patent Application Laid-Open No. 2004-242122
PTL 2
U.S. Pat. No. 6,882,315
PTL 3
Japanese Patent Application National Publication No. 2002-517001

### SUMMARY OF INVENTION

### Technical Problem

In the radio positioning system of the known synchronous method, however, the radio terminal needs to generate a clock. Therefore, there is a problem that the reference clock is varied in the radio terminal due to the influence of a multi-path propagation path and thus jitter readily occurs at a response timing of the pulse sequence (that is, fluctuation of a delay time in a signal or the like). This is because the pulse sequence transmitted from the base station and received to generate the clock by the radio terminal is dramatically varied due to the influence of multi-path interference or Doppler fading under an actual environment.

It is therefore an object of the present invention to provide a positioning system and a positioning method capable of improving positioning accuracy while preventing jitter from occurring.

### Solution to Problem

According to an aspect of the invention, there is provided a positioning system including: a transmission apparatus which transmits a pulse signal sequence; an apparatus which is subject to positioning, and which includes an amplifier to amplify an input signal and a transmitting/receiving block to receive the pulse signal sequence, allow the amplifier to amplify the received pulse signal sequence, and transmit the amplified pulse signal sequence as a response pulse signal sequence; and a calculation apparatus, which is a separate apparatus from the transmission apparatus, and which includes a detecting block to detect a reception timing of the response pulse signal sequence and a position calculating block to calculate a position of the apparatus that is subject to positioning based on a propagation time required from a transmission timing of the pulse signal sequence to the detected reception timing.

According to another aspect of the invention, there is provided a positioning method of a positioning system including a transmission apparatus which transmits a pulse signal sequence, an apparatus that is subject to positioning, and a calculation apparatus which is a separate apparatus from the transmission apparatus and which calculates a position of the apparatus that is subject to positioning, and this positioning method comprises: at the transmission apparatus, transmitting the pulse signal sequence; at the apparatus that is subject to positioning, receiving the pulse signal sequence, amplifying the received pulse signal sequence, and then transmitting the amplified pulse signal sequence as a response pulse signal sequence; and at the calculation apparatus, detecting a reception timing of the response pulse signal sequence and calculating the position of the apparatus that is subject to positioning based on a propagation time required from a transmission timing of the pulse signal sequence to the detected reception timing.

### Advantageous Effects of Invention

According to the present invention, it is possible to provide a positioning system and a positioning method capable of improving the positioning accuracy while suppressing occurrence of jitter.

### BRIEF DESCRIPTION OF DRAWINGS

FIG. 1 is a diagram illustrating a positioning system according to Embodiment 1 of the present invention;

FIG. 2 is a block diagram illustrating the configuration of a base station according to Embodiment 1 of the present invention;

FIG. 3 is a block diagram illustrating the configuration of a radio terminal according to Embodiment 1 of the present invention;

FIG. 4 is a diagram illustrating an example of the configuration of the positioning system according to Embodiment 1 of the present invention;

FIG. 5 is a diagram illustrating a UW bit sequence and an ID bit sequence;

FIG. 6 is a block diagram illustrating the configuration of a base station according to Embodiment 2 of the present invention;

FIG. 7 is a block diagram illustrating the configuration of a positioning station according to Embodiment 2 of the present invention;

FIG. 8 is a diagram illustrating an example of the configuration of a positioning system according to Embodiment 2 of the present invention;

FIG. 9 is a diagram illustrating the overall configuration of the positioning system including a plurality of base stations and a plurality of radio terminals;

FIG. 10 is a diagram illustrating an example of the configuration of a positioning system according to Embodiment 3 of the present invention;

FIG. 11 is a block diagram illustrating the configuration of a positioning station according to Embodiment 4 of the invention;

FIG. 12 is a diagram illustrating a position calculation process performed by an ID positioning block;

FIG. 13 is a diagram illustrating a positioning system according to Embodiment 5 of the invention; and

FIG. 14 is a block diagram illustrating the configuration of a radio terminal according to Embodiment 5 of the invention.

### DESCRIPTION OF EMBODIMENTS

Hereinafter, embodiments of the invention will be described in detail with reference to the drawings. In the embodiments, the reference numbers are given to the same constituent elements and the description thereof will not be repeated here.

### Embodiment 1

### Overview of Positioning System

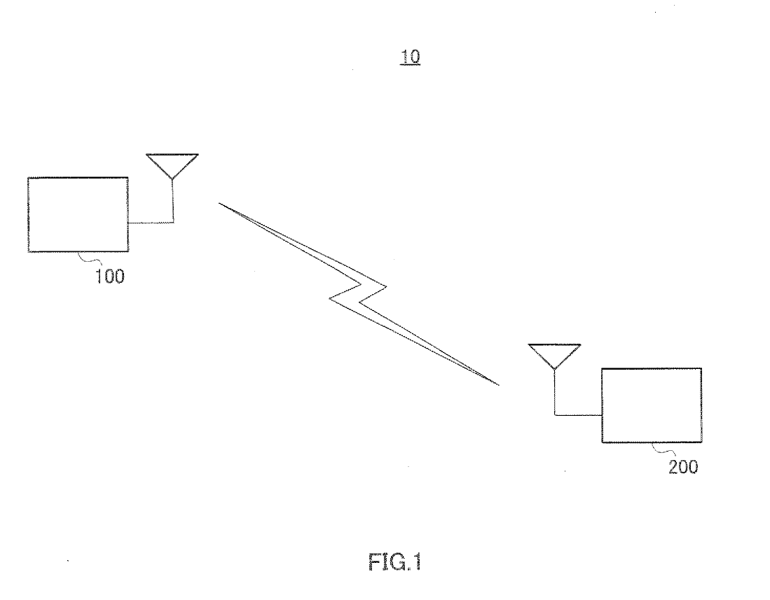

FIG. 1 is a diagram illustrating positioning system 10 according to Embodiment 1 of the present invention. In FIG. 1, positioning system 10 includes base station 100 and radio terminal 200, the position of which is measured by base station 100.

Base station 100 measures the position of radio terminal 200. An UWB impulse radio signal is used in the measuring of the position.

Base station 100 first transmits a pulse signal sequence. Radio terminal 200 receives the pulse signal sequence and transmits a response pulse signal sequence based on the received pulse signal sequence. Here, since a “semi-passive method” is applied to radio terminal 200, the received pulse signal sequence is transmitted as the response pulse signal sequence by being amplified and then retransmitted in radio terminal 200.

Base station 100 receives the response pulse signal sequence transmitted from radio terminal 200. Then, base station 100 measures a time-of-arrival of the received pulse signal sequence to determine the position of radio terminal 200 based on the measurement result.

Specifically, base station 100 measures the required roundtrip time, that is, measures the time it takes from a transmission timing of the pulse signal sequence to a reception timing (that is, time-of-arrival (TOA)) of the response pulse signal sequence corresponding to the pulse signal sequence. Then, base station 100 calculates the separate distance between base station 100 and radio terminal 200 from the measured roundtrip time.

[Configuration of Base Station 100]

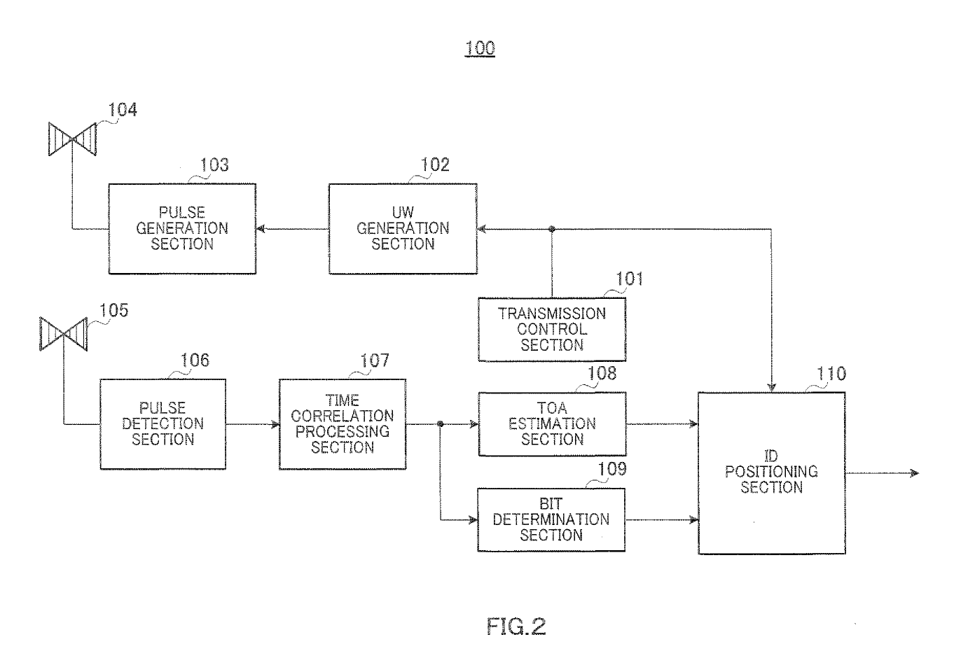

FIG. 2 is a block diagram illustrating the configuration of base station 100 according to Embodiment 1 of the present invention. In FIG. 2, base station 100 includes transmission control block 101, unique word (UW) generation block 102, pulse generation block 103, antennas 104 and 105, pulse detection block 106, time correlation processing block 107, TOA estimation block 108, bit determination block 109, and ID positioning block 110.

<Configuration of Transmission System>

Transmission control block 101 outputs a positioning start signal to UW generation block 102, when starting a positioning operation.

When UW generation block 102 receives the positioning start signal, UW generation block 102 generates a UW bit sequence and outputs the UW bit sequence to pulse generation block 103. The UW bit sequence indicates a unique word (UW) which is identification information of base station 100 itself. The UW bit sequence is generated by modulating the UW in accordance with on-off keying (OOK). The UW bit sequence constitutes a single frame with a predetermined number. The UW bit sequence is repeatedly transmitted in a frame unit.

Pulse generation block 103 generates a pulse at a predetermined period and generates a pulse sequence. Further, pulse generation block 103 generates a radio pulse sequence of a radio frequency band by modulating the generated pulse sequence along the UW bit sequence received from UW generation block 102 in accordance with OOK. The radio pulse sequence is transmitted through antenna 104.

<Configuration of Reception System>

Pulse detection block 106 receives the response pulse signal sequence through antenna 105 transmitted from radio terminal 200. Pulse detection block 106 detects a baseband signal obtained by detecting the envelope of the received pulse signal sequence to time correlation processing block 107. Pulse detection block 106 includes a low-noise-amplifier (LNA), a diode detecting block, a comparator, or an A/D converter. A radio receiving process block (not shown) is installed in the input terminal of pulse detection block 106. The radio receiving process block performing down-converting or the like on the received pulse signal sequence, and then outputs the processed received pulse signal sequence to pulse detection block 106.

Time correlation processing block 107 has information regarding a plurality of UW candidates. Time correlation processing block 107 generates a UW replica for each UW candidate. Time correlation processing block 107 performs a mutual correlation process on the generated UW replica and the baseband signal received from pulse detection block 106 on a time axis. A temporal correlation result obtained through the mutual correlation process is output in the frame unit to TOA estimation block 108. The temporal correlation result is a propagation path delay profile that is expressed by the signal intensity of a received pulse and the time-of-arrival TOA.

TOA estimation block 108 forms a averaged delay profile by summing the delay profiles of a plurality of frames and detects the peak expressed in the averaged delay profile. The position of the peak (that is, a timing (TOA) at which the peak is detected) is output as a TOA estimation result.

Bit determination block 109 detects the signal intensity expressed in the delay profile received from time correlation processing block 107 in the frame unit and compares the magnitudes of the detected intensity and a predetermined threshold value to each other. Then, bit determination block 109 sequentially stores bit values corresponding to the comparison result. Thus, a bit sequence can be obtained which is based on the comparison result obtained by comparing the magnitudes of the detected intensities of the plurality of frames and the threshold value to each other. This bit sequence means identification information of radio terminal 200, as described below.

ID positioning block 110 calculates the position of radio terminal 200 to be positioned. In this embodiment, ID positioning block 110 calculates, as information regarding the position of radio terminal 200, the distance between base station 100 and radio terminal 200 to be positioned. Specifically, ID positioning block 110 measures the required roundtrip time from the reception timing of the positioning start signal to the time-of-arrival measured by TOA estimation block 108. Further, based on the required roundtrip time, ID positioning block 110 calculates the separate distance between base station 100 and radio terminal 200 corresponding to the identification information received from bit determination block 109.

[Configuration of Radio Terminal 200]

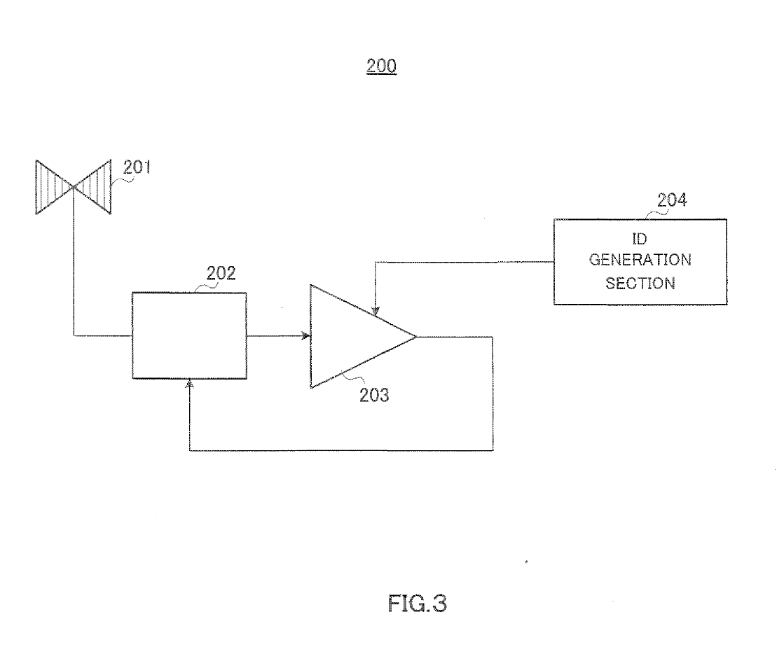

FIG. 3 is a block diagram illustrating the configuration of radio terminal 200 according to Embodiment 1 of the present invention. In FIG. 3, radio terminal 200 includes UWB antenna 201, circulator 202, low-noise-amplifier (LNA) 203, and ID generation block 204.

Circulator 202 outputs the received pulse sequence received through UWB antenna 201 to LNA 203. Further, circulator 202 transmits a signal received from the LAN 203 through UWB antenna 201.

ID generation block 204 outputs an ID bit sequence representing the identification information (ID) of radio terminal 200 itself. ID generation block 204 outputs constituent bits of the ID bit sequence one by one for each frame.

LNA 203 amplifies the input pulse sequence in accordance with an applied voltage. The applied voltage is voltage value corresponding to the value of the bit received from ID generation block 204. Since the constituent bits are output per frame from ID generation block 204, the applied voltage value is switched per frame. For example, the applied voltage value switched at the beginning of the first frame is maintained up to the beginning of a second frame serving as the subsequent substitution timing. Thus, the identification information of radio terminal 200 formed by the plurality of bits can be substituted by the signal intensity of the plurality of frames. That is, the identification information of the radio terminal 200 formed by the plurality of bits can be converted as transition of the voltage of the plurality of frames.

[Operation of Positioning System]

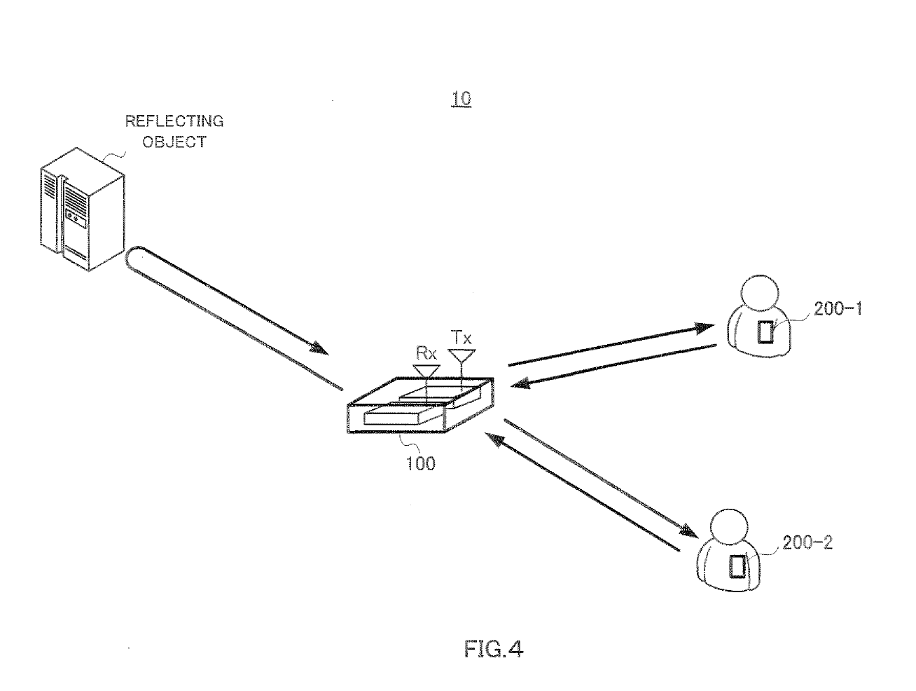

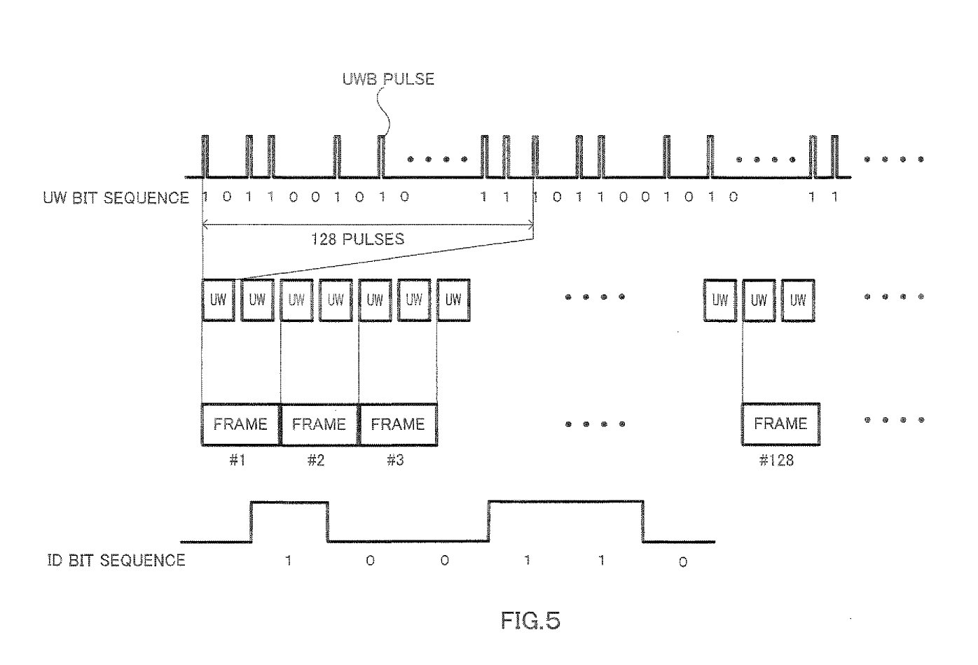

An operation of positioning system 10 having the above-described configuration will be described. FIG. 4 is a diagram illustrating an example of the configuration of positioning system 10. FIG. 5 is a diagram illustrating a UW bit sequence and the ID bit sequence.

(Transmitting Pulse Signal by Base Station 100)

UW generation block 102 of base station 100 starts generating the UW bit sequence, when receiving the positioning start signal. A bit pattern of the UW bit sequence is unique to base station 100 (see the uppermost end of FIG. 5). Here, the UW bit sequence is formed with 128 bits. For example, a PN sequence is used for the UW bit sequence. The PN sequence is a pseudo noise sequence. Specifically, the PN sequence is a sequence in which an auto-correlation function assumes values of two levels and in which the numbers of 0s and is vary only by one in one period. The maximum length shift register sequence (generally called M sequence) is known as the representative PN sequence.

Next, pulse generation block 103 modulates the pulse sequence including the plurality of pulses constant at an interval of the adjacent pulses along the UW bit sequence in accordance with OOK. Thus, it is possible to obtain a radio pulse sequence with a radio frequency band (see the uppermost end of FIG. 5). This radio pulse sequence is transmitted through antenna 104.

Here, N UW bit sequences form one frame. In the third portion from the uppermost end of FIG. 5, a case of “predetermined number N=2” is shown. Accordingly, the frame including two UW bit sequences is repeatedly transmitted.

(Reflection Operation of Radio Terminal 200)

The radio pulse sequence transmitted from base station 100 is transmitted to radio terminals 200-1 and 200-2. Then, radio terminals 200-1 and 200-2 transmit the response pulse sequence.

At this time, radio terminals 200-1 and 200-2 each superpose the ID information of the subject radio terminal to the response pulse sequence and transmit the response pulse sequence. For example, one-constituent bits can be delivered using the response pulse sequence of one frame by switching ON/OFF of LNA 203 per frame depending on whether each constituent bit of the ID information (formed by a plurality of bits) of radio terminal 200 is 1 or 0. Thus, radio terminals 200-1 and 200-2 can operate as a reflector of a signal-pulse and also can transmit the response pulse sequence in which the ID information of the subject radio terminal is superimposed on the pulse sequence (see the lowermost end of FIG. 5).

Radio terminals 200-1 and 200-2 transmit the response pulse sequence as a response pulse signal by basically amplifying the received pulse signal. That is, since radio terminals 200-1 and 200-2 operates the reflector of the single-pulse, radio terminals 200-1 and 200-2 can transmit the response pulse sequence in synchronization with the reference clock of base station 100 without generating a reference clock. Here, a method of the positioning system in which the radio terminal transmits the response pulse sequence just by basically amplifying the received pulse signal is referred to as a “semi-passive method.”

Further, since radio terminals 200-1 and 200-2 do not generate the reference signal, it is possible to suppress jitter from occurring in radio terminals 200 caused due to the influence on the multi-path propagation path. Thus, it is possible to stabilize the transmission timing of the response pulse sequence retransmitted from radio terminal 200.

(Receiving Response Pulse Signal by Base Station 100)

The pulse signal strings transmitted from radio terminal 200 is received by base station 100.

Pulse detection block 106 of base station 100 detects the received pulse signal sequence and outputs the obtained detection result to time correlation processing block 107.

Time correlation processing block 107 performs the mutual correlation process on the detection result and each UW bit sequence replica. Thus, it is possible to obtain the delay profile of each UW candidate. Since the same UW bit sequence is repeated in the response pulse signal sequence, time correlation processing block 107 repeats the mutual correlation process using one UW bit sequence replica. Thus, it is possible to obtain the plurality of delay profiles corresponding to the length of the UW bit sequences. In the mutual correlation process, an encoding gain can be ensured in accordance with the length of the UW bit sequence replica. Since UW is the individual identification information of each base station 100, the delay profile can be obtained for each base station 100. Here, since it is assumed that single base station 100 is used, time correlation processing block 107 performs the mutual correlation process on the detection result and the UW bit sequence replica of base station 100.

TOA estimation block 108 generates the averaged delay profile by summing the plurality of delay profiles obtained by time correlation processing block 107. The process of averaging the delay profiles is performed for each UW candidate. Then, the peak expressed in each synthesized delay profile is detected. The position of the peak (that is, the timing (TOA) at which the peak is detected) is output as the TOA estimation result.

Bit determination block 109 detects the signal intensity, which is expressed in each delay profile received from time correlation processing block 107, in the frame unit and compares the magnitudes of the detected signal intensity with the predetermined threshold value to each other. The bit value's corresponding to the comparison results are sequentially stored. Thus, it is possible to obtain the bit sequence based on the comparison result obtained by comparing the magnitudes of the detected signal intensities of the plurality of frames and the threshold value. Since the ID information of radio terminal 200 loaded on the response pulse sequence is transmitted, as described above, the bit sequence obtained from bit determination block 109 corresponds to the ID information of radio terminal 200. Since the ID information of radio terminals 200 is different from each other, as described above, radio terminal 200 of a transmission source of the received response pulse signal sequence can be specified by the bit sequence obtained from bit determination block 109. Since a terminal ID is not superimposed in the pulse signal sequence reflected and returned from the reflector shown in FIG. 4, the pulse signal sequence reflected from the reflector can be distinguished from the response pulse signal sequence.

ID positioning block 110 calculates the separate distance between base station 100 and radio terminal 200 to be positioned.

According to the present embodiment, as described above, in positioning system 10 which includes base station 100 and radio terminals 200 and measures the position of radio terminal 200 to be positioned using the pulse signal, pulse generation block 103 of base station 100 transmits the pulse signal sequence. Then, ID positioning block 110 calculates the roundtrip time from the transmission timing of the pulse signal sequence to the reception timing of the response pulse signal sequence transmitted from radio terminal 200 receiving the pulse signal sequence, and then calculates the position of radio terminal 200 based on the required roundtrip time. Here, the separate distance between base station 100 and radio terminal 200 is calculated as the information regarding the position of radio terminal 200.

LNA 203 of radio terminal 200 amplifies the received pulse signal sequence and transmits the amplified pulse signal sequence as the response pulse signal to base station 100.

Thus, since radio terminal 200 operates as the reflector of the single-pulse, radio terminal 200 can transmit the response pulse sequence in synchronization with the reference clock of base station 100 without generating a reference clock. Further, since radio terminal 200 does not need to generate a reference clock, it is possible to prevent jitter from occurring in radio terminal 200 due to the influence of the multi-path propagation path. Thus, since the transmission timing of the response pulse sequence retransmitted from radio terminal 200 can be stabilized, it is possible to improve the accuracy of TOA estimation. As a consequence, even when plural base stations 100 are not used, radio terminal 200 can be positioned with single base station 100. Accordingly, it is possible to improve the accuracy of positioning.

### Embodiment 2

Embodiment 2 relates to a positioning system in which the transmission system and the reception system of base station 100 of Embodiment 1 are separated from each other.

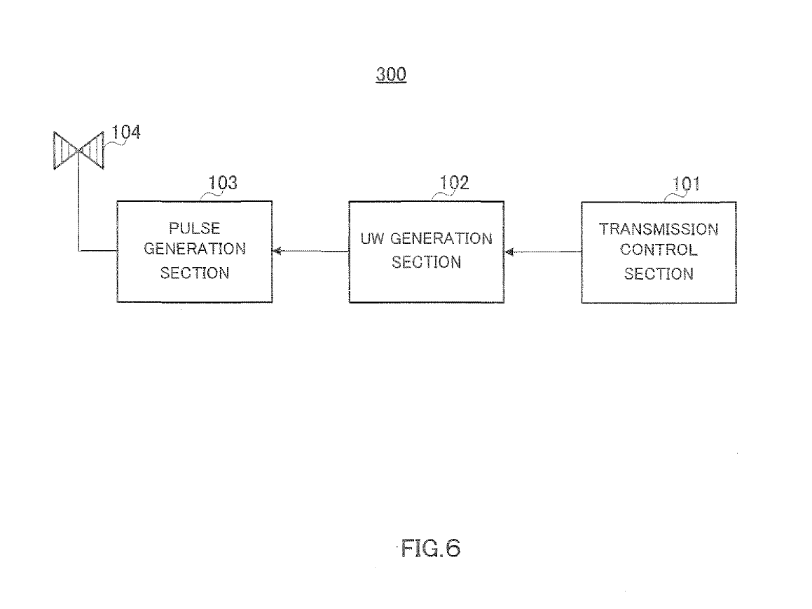

FIG. 6 is a block diagram illustrating the configuration of reference station 300 according to Embodiment 2 of the present invention. Reference station 300 corresponds to the transmission system of base station 100 of Embodiment 1.

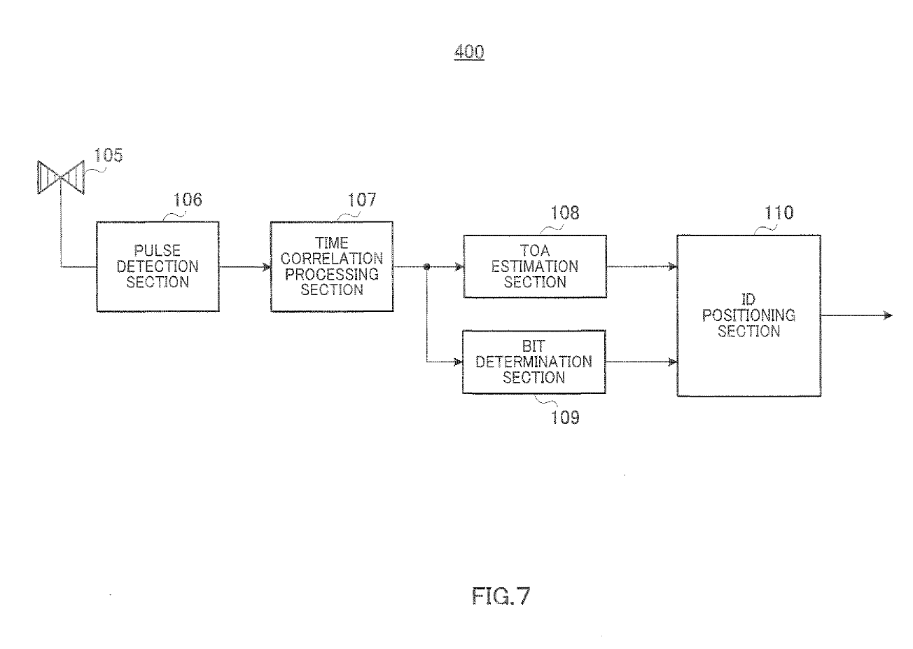

FIG. 7 is a block diagram illustrating the configuration of positioning station 400 according to Embodiment 2 of the present invention. Positioning station 400 corresponds to the reception system of base station 100 of Embodiment 1.

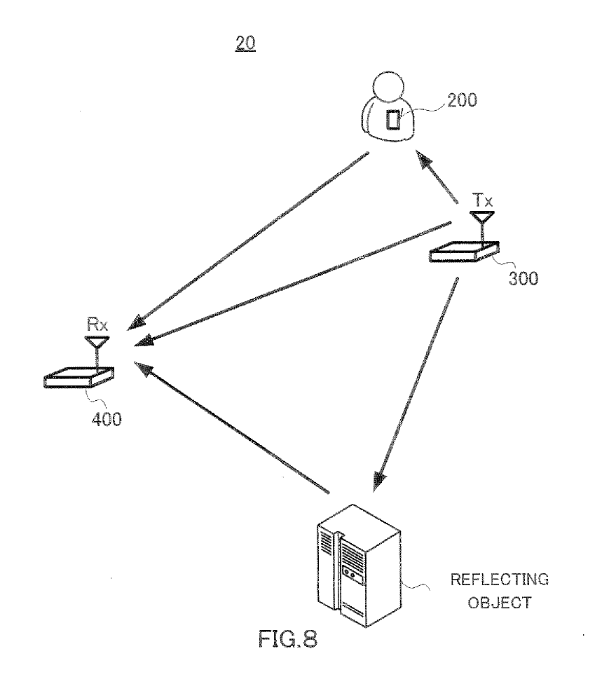

FIG. 8 is a diagram illustrating an example of the configuration of positioning system 20.

In positioning system 20, reference station 300 transmits the pulse signal sequence. Radio terminal 200 receives the pulse signal sequence and transmits the response pulse signal sequence based on the received pulse signal sequence.

Positioning station 400 receives the response pulse signal sequence transmitted from radio terminal 200. Then, positioning station 400 measures the time-of-arrival of the received pulse signal sequence and determines the position of radio terminal 200 based on the measurement result.

Specifically, positioning station 400 measures the time required by the bypass propagation path, that is, measures the time from the timing at which reference station 300 transmits the pulse signal sequence, to the timing (that is, the time-of-arrival (TOA)), at which positioning station 400 receives the response pulse signal sequence replied to the pulse signal sequence. Then, positioning station 400 calculates the position of radio terminal 200 based on the measured roundtrip time.

Here, the separate distance between positioning station 400 and radio terminal 200 is directly calculated as the information regarding the position of radio terminal 200, but a sum of the separate distance between reference station 300 and radio terminal 200 and the separate distance between radio terminal 200 and positioning station 400, that is, the distance of the bypass propagation path, is calculated. The distance of the bypass propagation path is completed as an index of the separate distance between reference station 300 and radio terminal 200.

Since reference station 300 and positioning station 400 are generally disposed in a quasi-fixed manner, the separate distance between reference station 300 and positioning station 400 is known in advance. Accordingly, ID positioning block 110 can hold the separate distance between reference station 300 and positioning station 400 in advance. However, even when the separate distance is not held in advance, the separate distance between reference station 300 and positioning station 400 can be calculated by using the pulse signal sequence transmitted from reference station 300 and directly arriving at positioning station 400 without passing through radio terminal 200. The pulse signal sequence directly arriving at positioning station 400 without passing through radio terminal 200 and the response pulse signal sequence arriving at positioning station 400 through radio terminal 200 can be distinguished from each other based on whether or not the ID information of radio terminal 200 is superimposed.

In this way, ID positioning block 110 of positioning station 400 can calculate the distance of the bypass propagation path and the separate distance between reference station 300 and positioning station 400. ID positioning block 110 can specify an elliptical sphere where radio terminals 200 exist based on the two pieces of distance information. Two focuses of the electrical sphere are the positions of reference station 300 and positioning station 400.

For example, generally, reference station 300 and radio terminals 200 are at installed the same height in the indoor environment (that is, reference station 300 and radio terminals 200 exist on the same plane) and positioning station 400 is installed at a relatively higher height. In general, radio terminals 200 that users carry exist on one plane.

Accordingly, ratio terminals 200 are located on the circumference of the ellipse which is the cross-sectional surface of the elliptical sphere that the plane where radio terminals 200 exist intersects.

According to this embodiment described above, in positioning system 20, reference station 300 transmits the pulse signal sequence and positioning station 400, which is a separate station from reference station 300, calculates the time required by the bypass propagation path from the transmission timing of the pulse signal sequence to the reception timing of the pulse signal sequence transmitted from radio terminal 200 receiving the pulse signal sequence and calculates the position of radio terminal 200 based on the calculated bypass propagation path turnaround time.

In this way, it is possible to improve the system coverage (measurable range) of the positioning system by configuring, as the separate stations, reference station 300 transmitting the pulse signal sequence and positioning station 400 receiving the response pulse signal sequence and calculating the position of radio terminal 200 based on the time required by the bypass propagation path. That is, since reference station 300 can be disposed freely, the distance between reference station 300 serving as a transmission source of the pulse signal sequence and radio terminal 200 can be shortened compared to a case where base station 100 of Embodiment 1 serves as a transmission source of the pulse signal sequence. Accordingly, radio terminal 200 can more reliably retransmit the pulse signal sequence.

In the above description, it has been assumed that one radio terminal 200 exists in positioning system 20 for facilitating the description. However, the invention is not limited thereto. Instead, a plurality of radio terminals 200 may exist. As described above, since the individual ID information of each radio terminal 200 is used, positioning station 400 can specify radio terminal 200 serving as a transmission source of the received response pulse signal based on the detected ID information.

Further, a plurality of reference stations 300 may exist in positioning system 20. Thus, it is possible to further improve the system coverage (measurable range) of positioning system 20A. In this case, a plurality of ellipses which are the cross-sectional surface of the elliptical sphere that the plane, where radio terminal 200 exists, intersects can be obtained for one radio terminal 200 excluding a case where the positional relationship of a plurality of reference stations 300 is special. Accordingly, the positions of radio terminals 200 can be narrowed down to four high positions by calculating the intersections of these ellipses. That is, it is possible to narrow down the positions of radio terminals 200 by the simple process of calculating the distance based on the time required by the bypass propagation path.

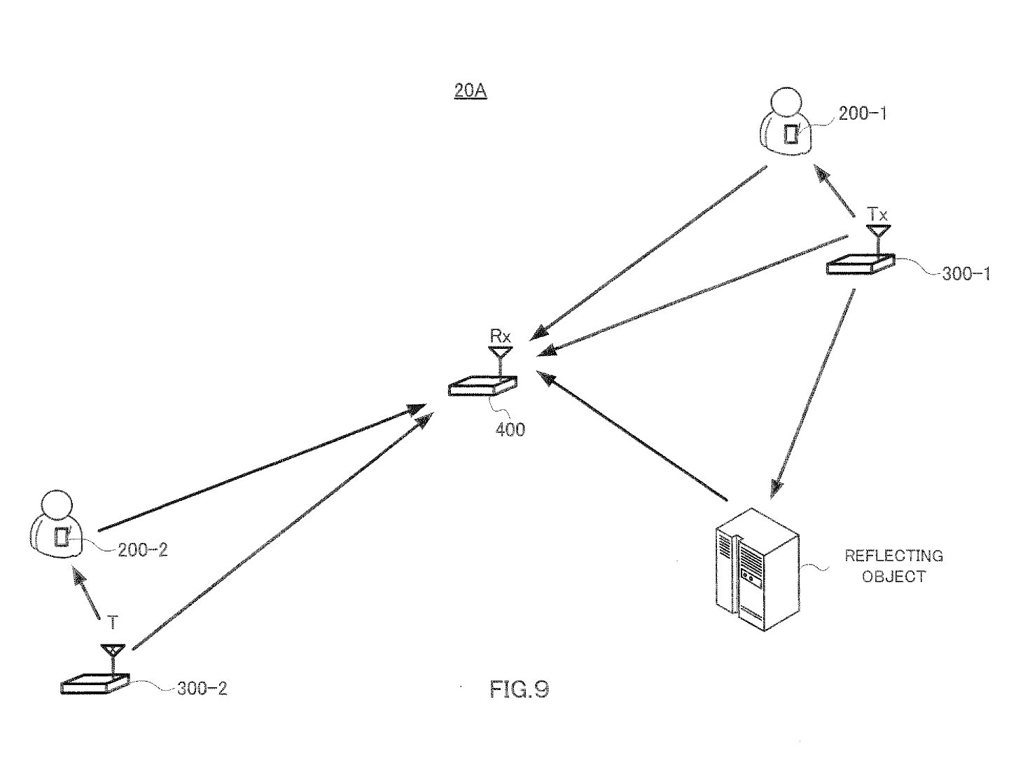

Furthermore, a plurality of radio terminals 200 and a plurality of reference stations 300 may exist. Thus, it is possible to further improve the system coverage (measurable range) of positioning system 20A. FIG. 9 is diagram illustrating the overall configuration of positioning system 20A in which a plurality of radio terminals 200 and a plurality of reference stations 300 exist. Two radio terminals 200 each receive the pulse sequence transmitted from nearby reference station 300 and retransmit the pulse sequence by superimposing the subject ID information. At this time, reference stations 300-1 and 300-2 transmit the pulse signal sequence generated using different UWs. Further, since two radio terminals 200-1 and 200-2 also have the different pieces of ID information, the different pieces of ID information are superimposed on two response pulse signal sequences retransmitted by radio terminals 200-1 and 200-2.

The UWs of reference stations 300-1 and 300-2 and the ID information of radio terminals 200-1 and 200-2 are registered in advance in positioning station 400. Time correlation processing block 107 of positioning station 400 calculates the delay profile for each UW by a time division process and a parallel calculation process. ID positioning block 110 distinguishes radio terminals 200-1 and 200-2 from each other based on the ID information by the use of the bit determination result for each UW.

However, positioning station 400 having the functions of the correlation reception of the pulse sequences, the ID detection, and the distance measurement is expensive. Therefore, when the installation number increases, the cost increases. Accordingly, for example, under the outdoor environment, it is preferable that positioning station 400 be installed on the ceiling or wall of line-of-sight in a positioning area near the middle of a room or a corridor. On the other hand, it is preferable that reference station 300 be installed near positioning station 400 to define the positioning area and be installed in the vicinity of the positioning area or in a so-called dead zone which is located out of the sight of positioning station 400. That is, since reference station 300 can be disposed freely, the distance between reference station 300 serving as the transmission source and radio terminal 200 can be shortened. Accordingly, radio terminal 200 can more reliably retransmit the pulse signal sequence.

When it can be grasped in advance that the movement line of radio terminal 200 to be positioned is present, it is preferable that positioning station 400 and reference station 300 be installed so that the positioning area is located on the movement line at the time of introducing the system. Further, when the movement line is changed due to a change in the layout, the positioning area can be updated and restored efficiently not by rearranging positioning station 400 so as to correspond to the new line of flow, but by changing only the installation place of reference station 300.

### Embodiment 3

Embodiment 3 relates to a positioning system including base station 100 and reference station 300. That is, the positioning system includes positioning station 400 of Embodiment 2 and the reception system of base station 100.

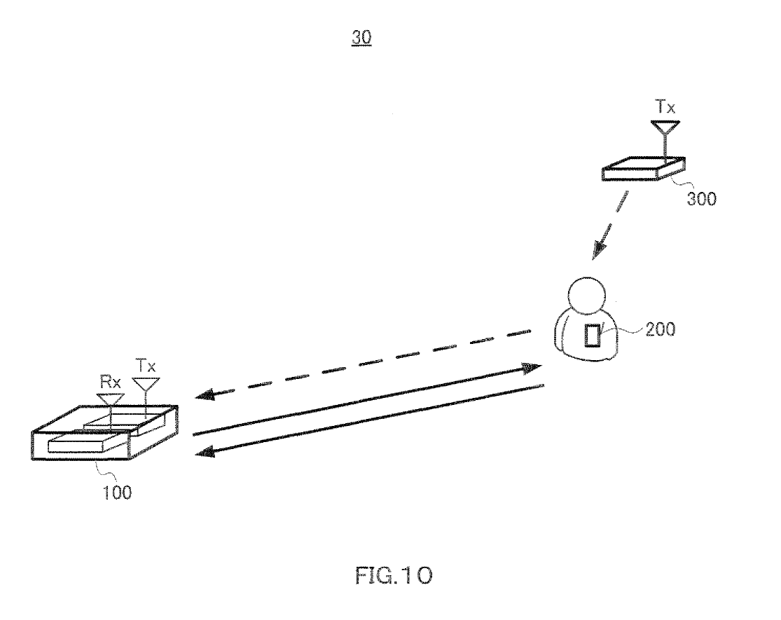

FIG. 10 is a diagram illustrating an example of the configuration of positioning system 30 according to Embodiment 3 of the present invention.

In FIG. 10, positioning system 30 includes base station 100, reference station 300, and radio terminal 200.

The distance measurement described in Embodiment 1 is performed between base station 100 and radio terminal 200. On the other hand, the distance measurement described in Embodiment 2 is performed in base station 100, reference station 300, and radio terminal 200.

That is, a sphere (a circumference of a circle when the plane where radio terminal 200 is located is specified) where radio terminal 200 is located about the position of base station 100 set as a center of the sphere is calculated between base station 100 and radio terminal 200. On the other hand, an elliptical sphere (a circumference of an ellipse when the plane where radio terminal 200 is located is specified) where radio terminal 200 is located as in Embodiment 2 is calculated in base station 100, reference station 300, and radio terminal 200.

When the plane where radio terminal 200 exists is specified, base station 100 can narrow down the position of radio terminal 200 to four high points by calculating the intersection between the circumference of the circle and the circumference of the ellipse. That is, the position of radio terminal 200 can be specified by the simple process of measuring the distance.

Since reference station 300 is also installed as the apparatus transmitting the pulse signal sequence as well as base station 100, it is possible to improve the system coverage (measurable range) of positioning system 30.

### Embodiment 4

In Embodiment 4, the position of the radio terminal can be specified by the positioning station.

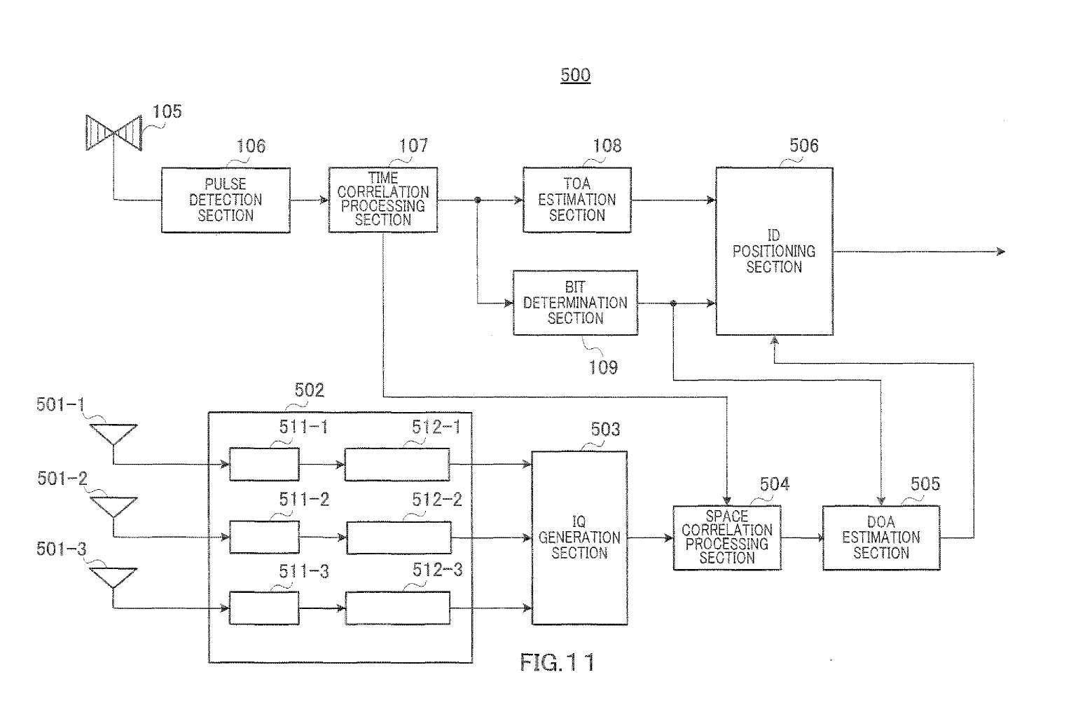

FIG. 11 is a block diagram illustrating the configuration of positioning station 500 according to Embodiment 4 of the invention. In FIG. 11, positioning station 500 includes an array antenna including array antenna elements 501-1 to 501-3, array reception block 502, IQ generation block 503, space correlation processing block 504, DOA estimation block 505, and ID positioning block 506.

Array antenna elements 501-1 to 501-3 constitute an array antenna for DOA estimation. Array antenna elements 501-1 to 501-3 may select and receive a narrow band as a bandwidth necessary for DOA estimation, when receiving UWB pulses of a bandwidth of 500 MHz or more. Accordingly, UWB antenna 105 needs a wideband antenna only for UWB, whereas array antenna elements 501-1 to 501-3 can also a single resonant antenna such as a monopole antenna.

Array reception block 502 converts signals received through array antenna elements 501-1 to 501-3 into inter-frequency (IF) signals and outputs the converted signals to IQ generation block 503. Array reception block 502 includes RF blocks 511-1 to 511-3 and IF blocks 512-1 to 512-3. RF blocks 511-1 to 511-3 include a band-pass-filter (BPF) of an LNA or RF band. IF blocks 512-1 to 512-3 include a down-converter or a BPF of an IF band. The IF signal output from array reception block 502 has a limited band of, for example, 20 MHz or less.

Array antenna element 501-1, RF block 511-1, and IF block 512-1 constitute a first reception system, array antenna element 501-2, RF block 511-2, and IF block 512-2 constitute a second reception system, and array antenna element 501-3, RF block 511-3, and IF block 512-3 constitute a third reception system.

IQ generation block 503 obtains an orthogonalized IQ baseband signal by performing A/D conversion on the IF signal received from array reception block 502 and performing IQ orthogonalization on the converted IF signal. The A/D conversion and the IQ orthogonalization are performed for each IF signal of each reception system. The IQ baseband signal obtained by each reception system is output to space correlation processing block 504.

Space correlation processing block 504 performs a spatial mutual correlation process using the IQ baseband signal obtained by each receiving antenna paths. That is, space correlation processing block 504 mutually correlates two IQ baseband signals of each the receiving antenna path. Accordingly, the spatial correlation result obtained by the mutual correlation on the spatial axis can be obtained as a correlation matrix. The correlation matrix is output in the frame unit by DOA estimation block 505 like time correlation processing block 107. Further, frame synchronization is established using a timing signal of a frame period output from time correlation processing block 107.

DOA estimation block 505 performs addition averaging on the correlation matrix input in the frame unit. The addition averaging is performed for each of the identification information received from bit determination block 109. DOA estimation block 505 obtains the DOA estimation result by executing a DOA estimation algorithm such as a beamformer method, a CAPON method, a MUSIC method, a SAGE method by the use of the correlation matrix subjected to the addition averaging. That is, DOA estimation block 505 can obtain the DOA estimation result for each radio terminal 200 by performing the addition averaging process and the DOA estimation process on the correlation matrix for each radio terminal 200 corresponding to the identification information received from bit determination block 109.

Like ID positioning block 110, ID positioning block 506 calculates the separate distance between base station 100 and radio terminal 200 corresponding to the identification information received from bit determination block 109 based on the required roundtrip time. Thus, ID positioning block 506 can specify an elliptical sphere where radio terminal 200 exists based on the distance of the bypass propagation path and the separate distance between reference station 300 and positioning station 500, as in Embodiment 2.

Based on the DOA estimation result, ID positioning block 506 calculates the direction in which radio terminal 200 corresponding to the identification information received from bit determination block 109 is located. That is, ID positioning block 506 calculates an azimuth angle Φ and an elevation angle θ representing the direction of radio terminal 200 viewed from positioning station 500. Here, the coordinate origin serving as a reference of the angle and the distance is set to the position of positioning station 500 or the position of reference station 300 of which the position is known in advance.

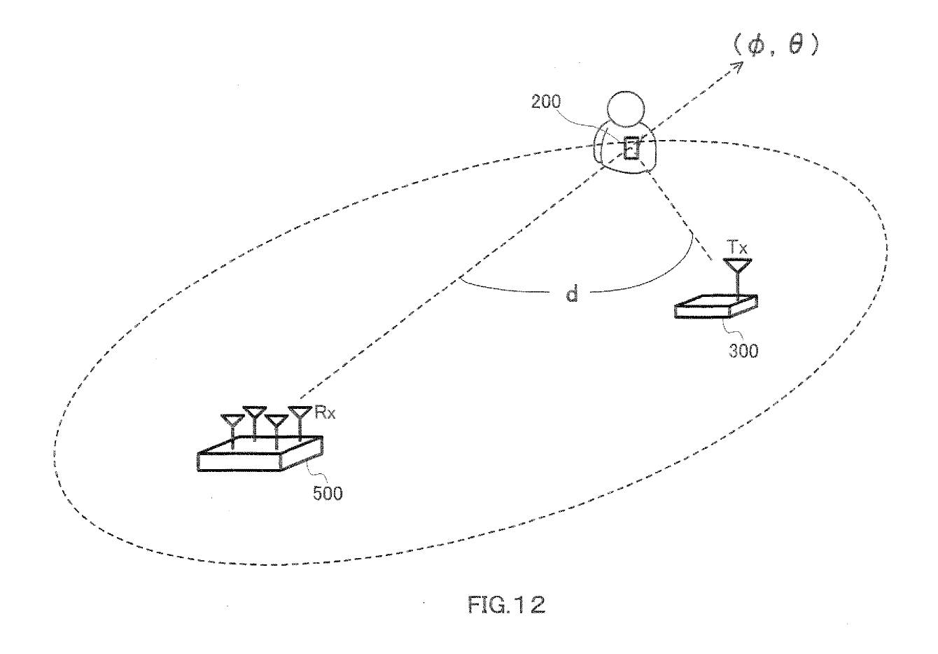

As shown in FIG. 12, ID positioning block 506 calculates an intersection between the elliptical sphere and a line segment extending from positioning station 500 in the direction indicated by the vector expressed by azimuth angle Φ and elevation angle θ. The coordinates of the intersection is the location coordinates of radio terminal 200.

The reason for setting the number of array elements for DOA estimation to 3 in the above description is that at least three elements are required for two-dimensional DOA estimation. That is, the number of array elements is not particularly limited, as long as the number of array elements is 3 or more in that three or more array elements can realize the above-described function.

The IF bandwidth of 20 MHz or less has been exemplified as the bandwidth used for the DOA estimation. However, this bandwidth is just a reference value when bandwidth of 3 to 10 GHz which is the RF band of microwave UWB is assumed to be used. In regard to the DOA estimation by the array antenna, there is theoretically a restriction on a fractional bandwidth of a central frequency of the RF band. Therefore, the design has to be practically realized in consideration of the restriction. That is, when the RF frequency increases, the IF bandwidth is consequently enlarged.

Positioning station 500 may further include the reception system of base station 100. Thus, the measurable range can be enlarged. As described in Embodiment 2 and Embodiment 3, the position of radio terminal 200 is narrowed down to four high points, and the direction in which radio terminal 200 is located can be used to specify the position of radio terminal 200, so that it is possible to further improve the accuracy of positioning.

For facilitating the description above, it has been assumed that the positioning system includes single positioning station 500 and single reference station 300. However, a plurality of positioning stations 500 may exist. Thus, it is possible to enlarge the measurable range of the entire system. Moreover, a plurality of positioning stations 500 and a plurality of reference stations 300 may exist. A single, plurality of positioning stations and a plurality of reference stations may be used. Thus, it is possible to further enlarge the measurable range of the entire system.

According to this embodiment, as described above, DOA estimation block 505 of positioning station 500 calculates the direction in which radio terminal 200 by setting the position of positioning station 500 as a reference. ID positioning block 506 calculates, as the position of radio terminal 200, the intersection between the line segment, which extends from the position of positioning station 500 in the calculated direction, and the elliptical sphere, in which the positions of positioning station 500 and reference station 300 are set as two focuses and the sum of distances from the two focuses to an arbitrary point on a surface of the elliptical sphere is the distance of the bypass propagation path.

Thus, the position of radio terminal 200 can be narrowed down to one point.

### Embodiment 5

In Embodiment 5, the radio terminal is configured to have both the function of radio terminal 200 of Embodiment 1 and the function of reference station 300 of Embodiment 2. That is, Embodiment 5 relates to a positioning system that has the configuration of radio terminal 200 and the configuration of the transmission system of base station 100 according to Embodiment 1.

[Overview of Positioning System]

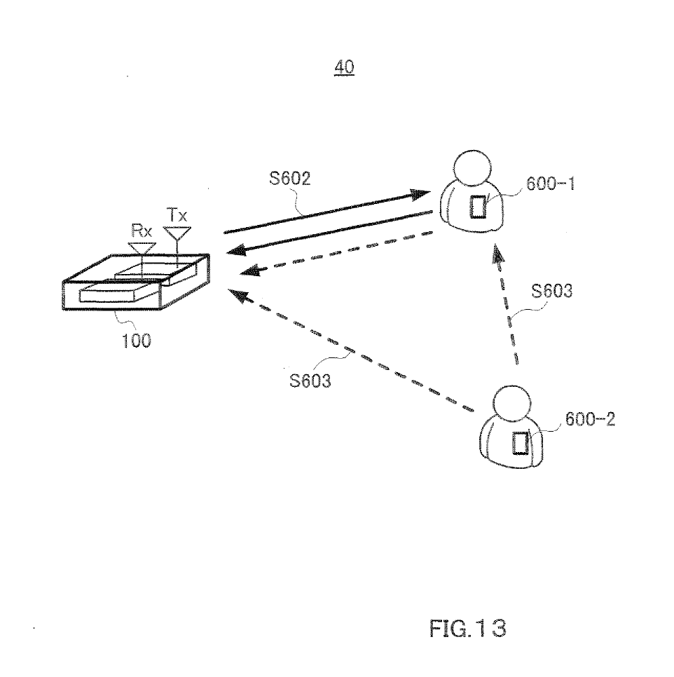

FIG. 13 is a diagram illustrating an example of the configuration of positioning system 40 according to Embodiment 5 of the invention.

In FIG. 13, positioning system 40 includes base station 100 and radio terminals 600-1 and 600-2.

Radio terminals 600-1 and 600-2 have the configuration of the transmission system of base station 100, as described above. That is, radio terminals 600-1 and 600-2 have both an active tag function (that is, the function of autonomously transmitting the pulse signal sequence like reference station 300 of Embodiment 2) and a semi-passive tag function (that is, the function of amplifying the pulse signal sequence and retransmitting the amplified pulse signal sequence only when receiving a desired pulse signal sequence like radio terminal 200 of Embodiment 1).

Radio terminals 600-1 and 600-2 switch between the active tag function and the semi-passive tag function depending on system environments.

Thus, radio terminals 600-1 and 600-2 can perform the positioning operation with base station 100, as in Embodiment 1. Further, radio terminals 600-1 and 600-2 can perform the positioning operation, when one of these radio terminals is in an active mode and the other one is in a semi-passive mode, as in Embodiment 2.

[Configuration of Radio Terminal 600]

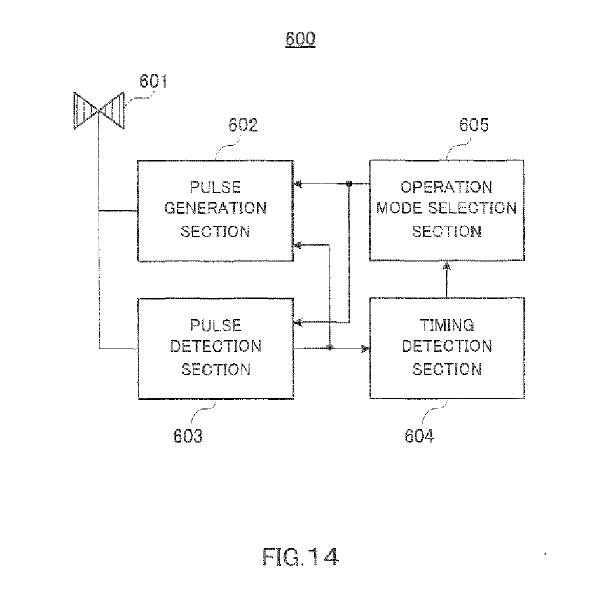

FIG. 14 is a block diagram illustrating the configuration of radio terminal 600 according to Embodiment 5 of the invention. In FIG. 14, radio terminal 600 includes UWB antenna 601, pulse generation block 602, pulse detection block 603, timing detection block 604, and operation mode selection block 605.

Pulse detection block 603 detects the envelope of the pulse signal sequence received through UWB antenna 601 and outputs the detection result to timing detection block 604 and pulse generation block 602. Further, when pulse detection block 603 receives a control signal for selecting the active mode as a mode from operation mode selection block 605, pulse detection block 603 stops an operation during the autonomous transmission of the pulse signal sequence by pulse generation block 602. Thus, it is possible to prevent returning reception of the pulse signal sequence transmitted from the radio transmission itself and to prevent unnecessary power consumption.

Timing detection block 604 detects the reception timing of the pulse signal sequence transmitted from base station 100 based on the detection result (that is, a pulse detection waveform periodically received) of pulse detection block 603, and then output the detected reception timing to operation mode selection block 605.

Operation mode selection block 605 selects the active mode or the semi-passive mode as an operation mode based on the reception timing received from timing detection block 604. Specifically, operation mode selection block 605 basically selects the semi-passive mode. When the reception timing received from timing detection block 604 varies significantly or it is determined that the reception timing is not detectable, operation mode selection block 605 determines that the pulse signal sequence transmitted from base station 100 may not be received stably, and thus selects the active mode. At this time, operation mode selection block 605 outputs a control signal indicating that the active mode is selected as the mode to pulse detection block 603 and pulse generation block 602.

In the case of the semi-passive mode, pulse generation block 602 is configured to include circulator 202 and LNA 203 of radio terminal 200 of Embodiment 1 so as to operate the reflection operation in the semi-passive mode. Further, in the case of the active mode (that is, when receiving the control signal indicating that the active mode is selected), pulse generation block 602 stops the reflection operation and transmits the pulse signal sequence only during the autonomous transmission period.

[Operation of Positioning System]

First, base station 100 transmits pulse signal sequence S602. Here, since radio terminal 600-1 operates in the semi-passive mode, the radio terminal 600-1 receives pulse signal sequence 5602 from base station 100 and transmits the response pulse signal sequence based on the received pulse signal sequence. At this time, base station 100 receives the response pulse signal sequence transmitted from radio terminal 600-1. Then, base station 100 measures the time-of-arrival of the received pulse signal sequence and determines the position of radio terminal 600-1 based on the measurement result.

Next, radio terminal 600-2 operates in the semi-passive mode. Here, since radio terminal 600-2 exists within the coverage area of base station 100, it is assumed that pulse signal sequence S602 from base station 100 is not stably detectable. In this case, radio terminal 600-2 is switched from the semi-passive mode to the active mode. That is, operation mode selection block 605 outputs the control signal to pulse generation block 602 so that the pulses are autonomously transmitted.

Here, radio terminal 600-1 receives pulse signal sequence 5602 transmitted from base station 100 and transmits the response pulse signal sequence. Likewise, radio terminal 600-2 receives pulse signal sequence 5603 transmitted from radio terminal 600-2 and transmits the response pulse signal sequence.

At this time, the transmission period of the pulse signal sequence transmitted from base station 100 is set in advance to be different from that of the pulse signal sequence transmitted from radio terminal 600-2. Thus, radio terminal 600-1 can distinguish pulse signal sequence 5602 transmitted from base station 100 from pulse signal sequence 5603 transmitted from radio terminal 600-2. For example, by setting the pulse transmission period of base station 100 to 200 ns and setting the pulse transmission period of radio terminal 600-2 to 150 ns, radio terminal 600-1 detects the frequency component of the received pulse signal sequence to identify the transmission source.

As in Embodiment 2, pulse signal sequence 5603 transmitted from radio terminal 600-2 operating in the active mode like reference station 300 and pulse signal sequence 5602 transmitted from base station 100 may be generated using different UWs.

As described above, base station 100 can measure the position of radio terminal 600-1 operating in the semi-passive mode in accordance with the mode described in Embodiment 1. Further, base station 100 can specify the position of radio terminal 600-2 based on the position information after measuring the position of radio terminal 600-1. Specifically, base station 100 measures the time which the bypass propagation path requires, using the direct reception timing of pulse signal sequence 5603 transmitted from radio terminal 600-2 as the reference. That is, base station 100 measure a time difference up to the timing (that is, the time-of-arrival (TOA)) at which the response pulse signal sequence of radio terminal 600-1 to pulse signal sequence 5603 is received. Then, base station 100 calculates the position of radio terminal 600-2 using the measured time difference and the position of radio terminal 600-1 measured in advance.

When radio terminal 600-1 receives the pulse signal sequence transmitted from base station 100, radio terminal 600-1 transmits the response pulse signal sequence on which the ID information of this radio terminal is superimposed. On the other hand, when radio terminal 600-1 receives the pulse signal sequence transmitted from radio terminal 600-2, the ID information is not superimposed. In other words, when radio terminal 600-1 relays the pulse signal sequence transmitted from radio terminal 600-2, radio terminal 600-1 operates so that ID of all “1s” is loaded. Such a transmission function is realized in pulse generation block 602. Accordingly, in the pulse signal sequence transmitted from radio terminal 600-1, the ID information of the radio terminal itself is superimposed in accordance with the method described in Embodiment 1.

### Other Embodiments

(1) In the above-described embodiments, the pulse signal sequence has been formed by the OOK modulation, but the invention is not limited thereto. Instead, the pulse signal may be formed by another modulation method such as BPSK.

(2) Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2009-064157, filed on Mar. 17, 2009, including the specification, drawings, and abstract, is incorporated herein by reference in its entirety.

### INDUSTRIAL APPLICABILITY

The positioning system and the positioning method according to the invention are capable of measuring the position of a radio tag and the like since it is possible to obtain the advantage of improving the positioning accuracy while preventing jitter from occurring.

### REFERENCE SIGNS LIST

10, 20, 30 Positioning system
100 Base station
101 Transmission control block
102 Unique word (UW) generation block
103, 602 Pulse generation block
104, 105 Antenna
106, 603 Pulse detection block
107 Time correlation processing block
108 TOA estimation block
109 Bit determination block
110, 506 ID positioning block
200, 600 Radio terminal
201, 601 UWB antenna
202 Circulator
203 LNA
204 ID generation block
300 Reference station
400, 500 Positioning station
501 Array antenna element
502 Array reception block
503 IQ generation block
504 Space correlation processing block
505 DOA estimation block
511 RF block
512 IF block
604 Timing detection block
605 Operation mode selection block

1-8. (canceled)

9. A positioning system comprising:
a transmission apparatus which transmits a pulse signal sequence;
an apparatus which is subject to positioning, and which includes:
an amplifier to amplify an input signal; and
a transmitting/receiving block to receive the pulse signal sequence, allow the amplifier to amplify the received pulse signal sequence, and transmit the amplified pulse signal sequence as a response pulse signal sequence; and
a calculation apparatus, which is a separate apparatus from the transmission apparatus, and which includes:
a detecting block to detect a reception timing of the response pulse signal sequence; and
a position calculating block to calculate a position of the apparatus that is subject to positioning based on a propagation time required from a transmission timing of the pulse signal sequence to the detected reception timing, wherein:
the calculation apparatus further includes:
an array antenna to have a plurality of antenna elements;
a receiving block to receive the response pulse signal sequence through the array antenna and narrow a band of the received response pulse signal sequence; and
a direction calculating block to calculate a direction of a position at which the apparatus that is subject to positioning is located, with respect to the calculation apparatus, based on the response pulse signal sequence with the narrowed band; and
the position calculating block calculates a bypass propagation distance based on the required propagation time, the bypass propagation distance being a sum of a first separate distance between the transmission apparatus and the apparatus that is subject to positioning and a second separate distance between the apparatus that is subject to positioning and the calculation apparatus, and calculates, as the position of the apparatus that is subject to positioning, an intersection between a line segment, which extends from the position of the calculation apparatus in the calculated direction, and an elliptical sphere, in which positions of the calculation apparatus and the transmission apparatus are two focuses and in which a sum of distances from the two focuses to an arbitrary point on a surface of the elliptical sphere matches the bypass propagation distance.

10. The positioning system according to claim 9, wherein:
the amplifier amplifies the input signal at an amplification factor corresponding to an application voltage; and
the apparatus that is subject to positioning further includes a voltage application block to apply a voltage to the amplifier in a pattern corresponding to identification data that is unique to the apparatus that is subject to positioning.

11. The positioning system according to claim 9, wherein:
the positioning system includes a plurality of the transmission apparatuses; and
each transmission apparatus includes a generating block to generate the pulse signal sequence based on identification data that is unique to the transmission apparatus.

12. The positioning system according to claim 9, wherein:
the calculation apparatus further includes a transmitting block to transmit the pulse signal sequence;
the detecting block detects, as a second reception timing, a reception timing of a response pulse signal transmitted from the apparatus that is subject to positioning, based on the pulse signal sequence transmitted from the transmitting block; and
the position calculating block calculates the second separate distance based on a roundtrip time required from a second transmission timing of the pulse signal sequence transmitted from the transmitting block to the detected second reception timing, calculates the bypass propagation distance based on the required propagation time, and calculates the position of the apparatus that is subject to positioning based on the second separate distance and the bypass propagation distance.

13. The positioning system according to claim 12, wherein the position calculating block calculates, as the position of the apparatus that is subject to positioning, an intersection between a sphere, in which the second separate distance is a radius of the sphere and in which the position of the calculation apparatus is a center of the sphere, and the elliptical sphere.

14. The positioning system according to claim 9, wherein:
the apparatus that is subject to positioning has a first function of transmitting the response pulse signal sequence as the apparatus that is subject to positioning, and a second function as the transmission apparatus, and includes a mode selecting block to select between a first mode of operating the first function and a second mode of operating the second function based on a reception timing of the received pulse signal sequence; and
if the first mode is selected at the apparatus that is subject to positioning and a pulse signal sequence transmitted from another apparatus that is subject to positioning and that has selected the second mode is received, the apparatus that is subject to positioning transmits the response pulse signal sequence by superimposing identification information of the apparatus upon the response pulse signal sequence, and, if a pulse signal sequence transmitted from the transmitting apparatus is received, the apparatus that is subject to positioning transmits the response pulse signal sequence without superimposing identification information of the apparatus upon the response pulse signal sequence.

15. A positioning method using a positioning system including a transmission apparatus which transmits a pulse signal sequence, an apparatus which is subject to positioning, and a calculation apparatus which is a separate apparatus from the transmission apparatus and which calculates a position of the apparatus that is subject to positioning, the positioning method comprising:
at the transmission apparatus, transmitting the pulse signal sequence;
at the apparatus that is subject to positioning:
receiving the pulse signal sequence, amplifying the received pulse signal sequence, and then transmitting the amplified pulse signal sequence as a response pulse signal sequence;
at the calculation apparatus:
detecting a reception timing of the response pulse signal sequence;
at the calculation apparatus:
receiving the response pulse signal sequence through an array antenna and narrowing a band of the received response pulse signal sequence;
calculating a direction of a position at which the apparatus that is subject to positioning is located, with respect to the calculation apparatus, based on the response pulse signal sequence with the narrowed band;
calculating a bypass propagation distance based on a propagation time required from a transmission timing of the response pulse signal sequence and the detected reception timing, the bypass propagation distance being a sum of a first separate distance between the transmission apparatus and the apparatus that is subject to positioning and a second separate distance between the apparatus that is subject to positioning and the calculation apparatus; and
calculating, as the position of the apparatus that is subject to positioning, an intersection between a line segment, which extends from the position of the calculation apparatus in the calculated direction, and an elliptical sphere, in which positions of the calculation apparatus and the transmission apparatus are two focuses and in which a sum of distances from the two focuses to an arbitrary point on a surface of the elliptical sphere matches the bypass propagation distance.
